(19) United States
(12) Patent Application Publication
(10) Pub. No.: US 2004/0009775 A1
(43) Pub. Date: Jan. 15, 2004

(54) Method and apparatus for protecting contents transmitted between mobile phones and method of operating the mobile phones

(75) Inventors: Tae Woon Kang, Seoul (KR); Chang-nam Chu, Yongin-si (KR)

Correspondence Address: SUGHRUE MION, PLLC, 2100 PENNSYLVANIA AVENUE, N.W., WASHINGTON, DC, 20037, US

(73) Assignee: SAMSUNG ELECTRONICS CO., LTD.

(21) Appl. No.: 10/444,080

(22) Filed: May 23, 2003

(30) Foreign Application Priority Data
May 25, 2002 (KR) 2002-29117

(51) Int. Cl. H04Q 7/20

(52) U.S. Cl. 455/450; 455/449

(57) ABSTRACT

A method and an apparatus for protecting contents transmitted between mobile phones and a method of operating the mobile phones are provided. The method includes the first terminal encoding a predetermined channel key and transmitting the encoded channel key to the second terminal, the first terminal encoding communication contents using the channel key and transmitting the encoded communication contents to the second terminal, and the second terminal decoding the encoded channel key using the decoded channel key second terminal and decoding the encoded communication contents.

### BACKGROUND OF THE INVENTION

This application claims the priority of Korean Patent Application No. 2002-29117, filed May 25, 2002, in the Korean Intellectual Property Office, the disclosure of which is incorporated herein in its entirety by reference.

1. Field of the Invention

The present invention relates to a system for preventing wiretapping or bugging, and more particularly, to a method and an apparatus for protecting contents transmitted between mobile phones, which are capable of preventing the contents from being intercepted by setting up a security channel between the mobile phones, and a method of operating a mobile phone.

2. Description of the Related Art

General code division multiple access (CDMA) techniques adopt a frequency band extension communication method. The frequency band extension communication method has been used to prevent calls in wireless telecommunications from being intercepted and to make such calls less susceptible to noise.

FIG. 1 shows an example of communications using extension codes.

A transmitting party generates an extension signal (c) by multiplying data (a) to be transmitted by an extension code (b) and transmits the extension signal (c) along with a carrier wave. A receiving party obtains originally transmitted data (e), which are the same as the data (a), by multiplying the extension signal (c) received from the transmitting party by an extension code (d), which is the same as the extension code (b).

In FIG. 1, if the receiving party uses a different extension code from the one that the transmitting party has used, it is impossible for the receiving party to retrieve the original data transmitted from the transmitting party. In addition, in order for the receiving party to retrieve the original data transmitted from the transmitting party, the receiving party must have the same timing as the transmitting party in order to multiply the extension signal (c) by the extension code (d). These limitations make it possible to protect communications data transmitted between a transmitting party and a receiving party using an extension code.

However, it has been technically possible to intercept telecommunications using CDMA mobile phones, and equipment for wiretapping telecommunications has been developed. Recently, it has been possible to intercept telecommunications through a base station system or by tracking the frequencies of a mobile phone. In order to prevent wiretapping or interception of telecommunications, a security solution, i.e., Voice Privacy, has been suggested by QualComm Corp. However, the stability of the security solution, which is an encryption algorithm, has not yet been sufficiently verified.

Conventional security solutions for mobile phones mainly focus on the security relationship between a client and a server, and end-to-end security solutions for mobile phones rarely exist. Accordingly, it is necessary to take measures to protect call messages transmitted between communications terminals.

### SUMMARY OF THE INVENTION

The present invention provides a method and an apparatus for securing communications messages transmitted between mobile phones by setting up a security channel.

The present invention also provides a method of operating mobile phones having a function of securing call messages transmitted therebetween.

According to an aspect of the present invention, there is provided a method of protecting communication contents, which are transmitted between a first terminal and a second terminal. The method includes the first terminal encoding a predetermined channel key and transmitting the encoded channel key to the second terminal, the first terminal encoding communication contents using the channel key and transmitting the encoded communication contents to the second terminal, and the second terminal decoding the encoded channel key using the decoded channel key second terminal and decoding the encoded communication contents.

Preferably, the first terminal encodes the predetermined channel key using a predetermined public key.

Preferably, the predetermined public key is transmitted from the second terminal to the first terminal.

Preferably, the second terminal decodes the encoded channel key received from the first terminal using a predetermined private key.

Preferably, the second terminal decodes the encoded communication contents received from the first terminal using the decoded channel key.

According to another aspect of the present invention, there is provided a method of protecting communication contents transmitted between mobile phones. The method includes making mobile phones share a predetermined channel key according to an asymmetric encryption method, and encoding contents using the predetermined channel key according to a symmetric encryption method and transmitting the encoded contents between the mobile phones.

Preferably, making the mobile phones share a predetermined channel key includes transmitting a predetermined public key from a mobile phone, which is a contents protection requesting party, to another mobile phone, which is the intended correspondent of the contents protection requesting party, the intended correspondent encoding a predetermined channel key using the predetermined public key and transmitting the encoded channel key to the contents protection requesting party, and allowing the contents protection requesting party to decode the encoded channel key using a predetermined private key and to keep the decoded channel key.

Preferably, encoding the contents using the predetermined channel key according to a symmetric encryption method and transmitting the encoded contents between the mobile phones includes a mobile phone, which is a sending party, encoding contents using the predetermined channel key and transmitting the encoded contents to another mobile phone, which is a receiving party, and the receiving party decoding the encoded contents using the predetermined channel key shared with the sending party.

According to another aspect of the present invention, there is provided a mobile phone which protects contents. The mobile phone includes a memory for storing a private key and a public key used to perform asymmetric encryption, a channel key encoder and decoder for encoding a predetermined channel key using a public key of a second memory or decoding an encoded channel key using the private key, and a contents encoder and decoder for encoding contents to be protected decoding encoded contents, using the channel key.

According to another aspect of the present invention, there is provided a mobile phone which protects contents. The mobile phone includes a first memory for storing a public key, a second memory for storing a predetermined channel key, a channel key encoder for encoding the channel key stored in the second memory using the public key stored in the first memory and transmitting the encoded channel key, and a contents encoder for encoding predetermined contents using the channel key stored in the second memory and transmitting the encoded contents.

According to another aspect of the present invention, there is provided a mobile phone for protecting contents. The mobile phone includes a first memory for storing a private key, a channel key decoder for decoding encoded channel key input thereinto using the private key stored in the first memory, and a contents decoder for decoding an encoded contents input thereinto using the decoded channel key.

Preferably, the mobile phone further includes a second memory for storing a predetermined public key to be transmitted to a mobile phone, which has transmitted the encoded channel key to the channel key decoder.

According to another aspect of the present invention, there is provided a method of protecting contents, which is performed in terminals, which share a predetermined channel key following an asymmetric encryption method and perform, using the predetermined channel key, a contents protection mode, under which contents are transmitted between the terminals in a symmetric encryption method. The method includes outputting a contents protection request message along with a notification sound when a contents protection request is received, checking whether or not a user recognizes the contents protection request message while waiting for a predetermined amount of time, and outputting a message saying that contents protection is being performed and performing the contents protection mode, if the user has recognized the contents protection request message.

According to another aspect of the present invention, there is provided a computer program product for exchanging encrypted information between two terminals. The computer program product includes software instructions for enabling the computer to perform predetermined operations. The predetermined operations for exchanging encrypted information includes: encoding a predetermined channel key and transmitting the encoded channel key to a second terminal, encoding communication contents using the channel key and transmitting the encoded communication contents to the second terminal. Upon receiving the encoded channel key and encoded communication contents, the following predetermined operations are performed: namely, the encoded channel key is decoded. The decoded channel key is then used to decode the encoded communication contents.

### BRIEF DESCRIPTION OF THE DRAWINGS

The above features and advantages of the present invention will become more apparent by describing in detail exemplary embodiments thereof with reference to the attached drawings in which:

FIG. 1 is a diagram illustrating an example of communications using extension codes;

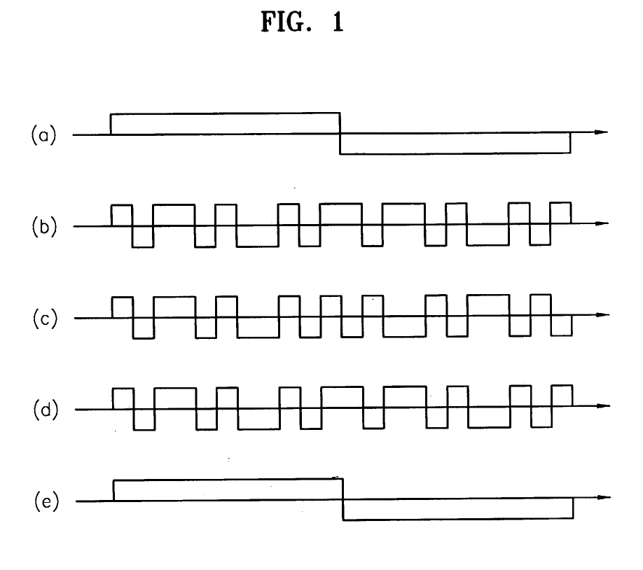

FIG. 2 is a schematic view of a mobile phone having a contents security function according to a preferred embodiment of the present invention;

FIG. 3 is a flowchart of a method of securing contents transmitted by a mobile phone according to a preferred embodiment of the present invention; and

FIG. 4 is a flowchart of a method of operating a mobile phone having a contents security function according to a preferred embodiment of the present invention.

### DETAILED DESCRIPTION OF THE INVENTION

Hereinafter, the present invention will be described more fully with reference to the accompanying drawings.

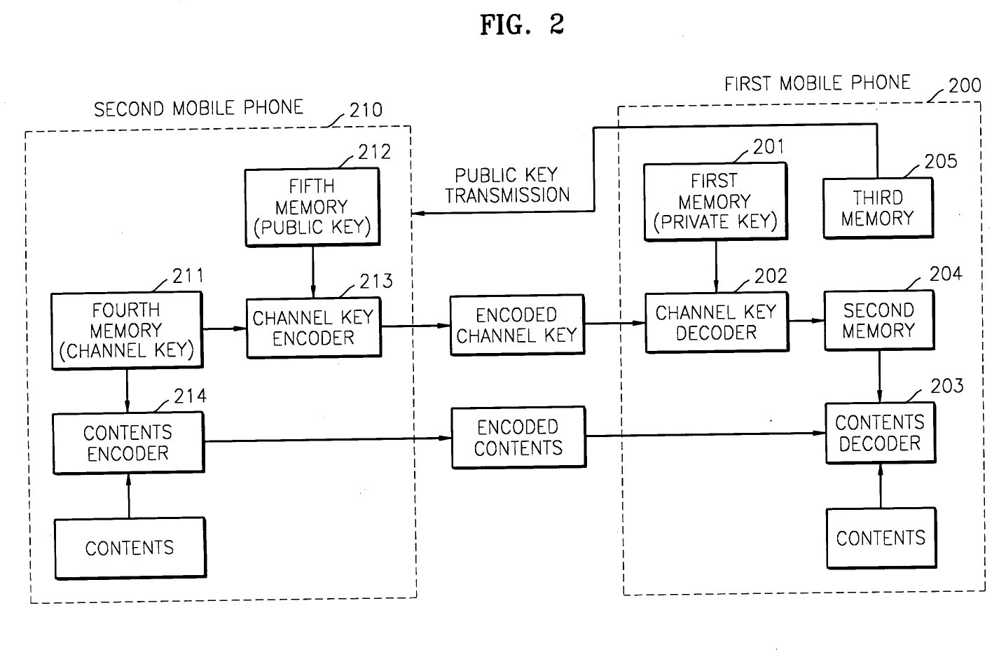

FIG. 2 is a schematic view of a mobile phone having a contents security function according to a preferred embodiment of the present invention. The structure of a mobile phone, which enables a user to communicate with another user by securing contents received from/transmitted to the other user's mobile phone, is as follows.

A first terminal 200, which is a party requesting contents security, includes a first memory 201, a channel key decoder 202, and a contents decoder 203.

The first memory 201 stores a private key and uses the private key to decode an encoded channel key input from a second terminal 210.

The channel key decoder 202 decodes the encoded channel key input from the second terminal 210 using the private key stored in the first memory 201. The decoded channel key may be stored in a second memory 204 in the first terminal 200.

The contents decoder 203 decodes encoded contents input from the second terminal 210 by using the decoded channel key.

The first terminal 200 may further include a third memory 205, in which a public key is stored. The public key is transmitted from the first terminal 200 to the second terminal 210 when there is a request from a user of the first terminal 200 to protect contents, for example, a request from a user of the first terminal 200 to protect voice information while he/she is talking over the phone.

The second terminal 210, which receives a contents security request from the first terminal 200, includes a fourth memory 211, a fifth memory 212, a channel key encoder 213, and a contents encoder 214.

The fourth memory 211 stores a predetermined channel key. The channel key may be randomly generated by the second terminal 210.

The fifth memory 212 receives a public key from a party requesting contents security, for example, the first terminal 200, and stores the public key.

The channel key encoder 213 encodes the channel key stored in the fourth memory 211 using the public key stored in the fifth memory 212 and transmits the encoded channel key to the first terminal 200.

The contents encoder 214 encodes the contents to be transmitted using the channel key in the fourth memory 211 and then transmits the encoded channel key to the first terminal 200.

In FIG. 2, a channel key is shared by both the first and second terminals 200 and 210 through an asymmetric encryption method. In other words, if the second terminal 210 encodes a channel key using a public key and transmits the encoded channel key to the first terminal 200, the first terminal 200 retrieves the encoded channel key using a private key. Contents, however, are transmitted between the first and second terminals 200 and 210 following a symmetric encryption method. In other words, if the second terminal 210 transmits contents encoded by using a channel key to the first terminal 200, the first terminal 200 decodes the encoded contents using the same channel key as the one that the second terminal 210 used. Even though the asymmetric encryption method requires much time, the asymmetric encryption method provides high stability. Accordingly, the asymmetric encryption method is used to encode and transmit a small amount of important data which needs to be protected.

Preferably, the public key and private key shown in FIG. 2 need to be changed regularly for the protection of contents.

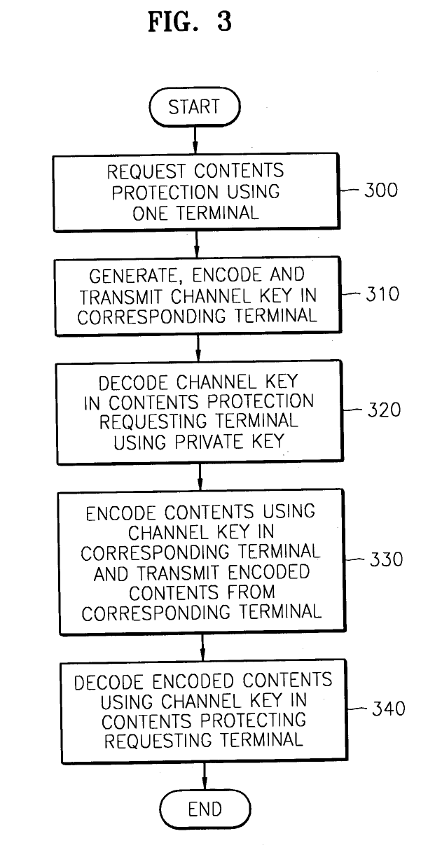

FIG. 3 is a flowchart of a method of protecting contents transmitted between mobile phones according to a preferred embodiment of the present invention. Referring to FIG. 3, a mobile phone (hereinafter, referred to as a requesting party) requests another mobile phone (hereinafter, referred to as the correspondent) to protect contents in step 300 when a user starts a contents protection mode using the requesting party. At this time, a predetermined public key may be transmitted from the requesting party to its correspondent.

The correspondent generates a channel key, encodes the channel key using the public key, and transmits the encoded channel key to the requesting party in step 310.

The requesting party decodes the encoded channel key received from the correspondent using a predetermined private key in step 320.

The correspondent encodes contents using the channel key and transmits the encoded contents to the requesting party in step 330.

The requesting party decodes the encoded contents using the decoded channel key in step 340.

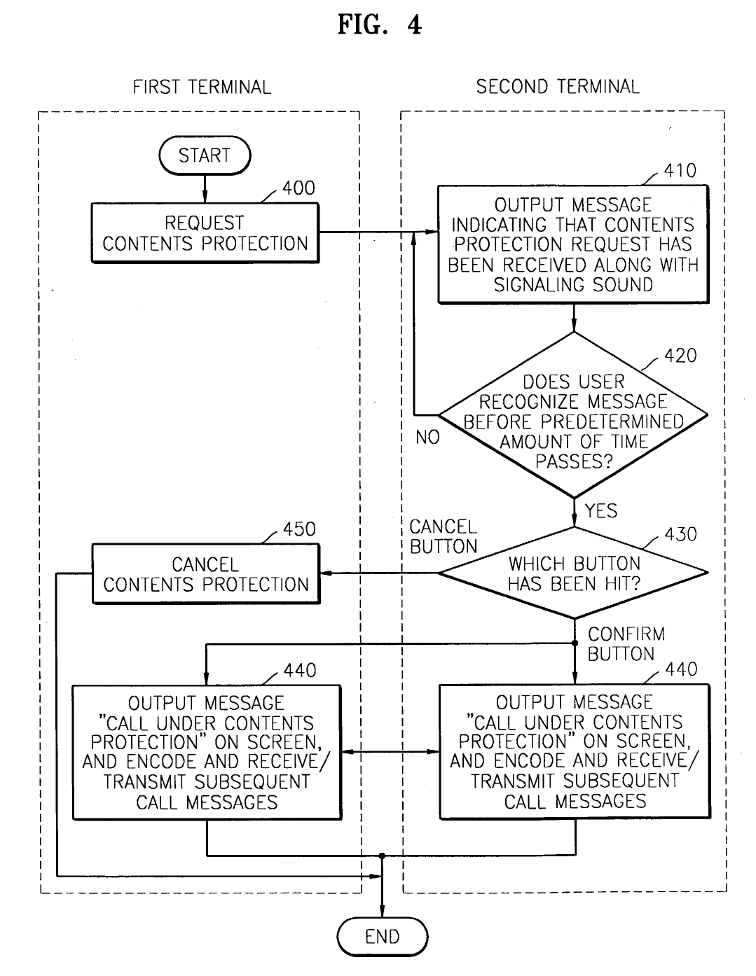

FIG. 4 is a flowchart of the operation of mobile phones performing a contents protection function according to a preferred embodiment of the present invention.

The operation of mobile phones will be described in the following paragraphs taking the first and second terminals 200 and 210 of FIG. 2 as examples.

The first terminal 200 requests the second terminal 210 to protect contents in step 400.

In step 410, the second terminal 210 outputs a message indicating that the contents protection request has been received and a predetermined notification sound.

In step 420, the second terminal 210 is allowed to have a predetermined amount of time before or after its user recognizes the message output in step 410. In other words, the method goes back to step 410 if a predetermined amount of time has not yet passed when the user of the second terminal 210 checks the message. On the other hand, if the user of the second terminal 210 has checked the message and the predetermined amount of time has passed, the method moves on to the next step.

In step 430, it is checked if the user of the second terminal 210 has checked the message by hitting a ‘confirm’ button. In other words, it is checked whether the user of the second terminal 210 has checked the message by hitting a ‘confirm’ button or a ‘cancel’ button of the second terminal 210.

If the user has checked the message by hitting the ‘confirm’ button in step 430, the first and second terminals 200 and 210 are both set up in a contents protection mode to perform the aforementioned contents protection function. Accordingly, the channel key is shared by the first and second terminals 200 and 210, contents, such as voice messages transmitted between the first and second terminals 200 and 210 while their users are talking on the phone, are transmitted between the first and second terminals 200 and 210 using the corresponding channel key, and a message indicating that the first and second terminals 200 and 210 are operating under the contents protection mode (or the first and second terminals 200 and 210 are performing the contents protection function) is output from both the first and second terminals 200 and 210 in step 440.

In step 430, if the user of the second terminal 210 has hit the ‘cancel’ button, in step 450, a message indicating that the contents protection function requested by the first terminal 200 is cancelled is transmitted to the first terminal 200, and there is no protection channel generated between the first and second terminals 200 and 210.

The above-identified invention may also be embodied in a computer program product, as will now be explained.

On a practical level, the software that enables the computer system to perform the operations described, may be supplied on any one of a variety of media. Furthermore, the actual implementation of the approach and operations of the invention are actually statements written in a programming language. Such programming language statements, when executed by a computer, cause the computer to act in accordance with the particular content of the statements. Furthermore, the software that enables a computer system to act in accordance with the invention may be provided in any number of forms including, but not limited to, original source code, assembly code, object code, machine language, compressed or encrypted versions of the foregoing, and any and all equivalents.

One of skill in the art will appreciate that “media”, or “computer-readable media”, as used here, may include a diskette, a tape, a compact disc, an integrated circuit, a ROM, a CD, a cartridge, a remote transmission via a communications circuit, or any other similar medium useable by computers. For example, to supply software for enabling a computer system to operate in accordance with the invention, the supplier might provide a diskette or might transmit the software in some form via satellite transmission, via a direct telephone link, or via the Internet. Thus, the term, “computer readable medium” is intended to include all of the foregoing and any other medium by which software may be provided to a computer.

Although the enabling software might be “written on” a diskette, “stored in” an integrated circuit, or “carried over” a communications circuit, it will be appreciated that, for the purposes of this application, the computer usable medium will be referred to as “bearing” the software. Thus, the term “bearing” is intended to encompass the above and all equivalent ways in which software is associated with a computer usable medium.

For the sake of simplicity, therefore, the term “program product” is thus used to refer to a computer useable medium, as defined above, which bears in any form of software to enable a computer system to operate according to the above-identified invention.

Thus, the invention is also embodied in a program product bearing software which enables a computer to exchange encrypted information according to the invention. Specifically, the software instructions enable the computer to perform at least the following predetermined operations. A predetermined channel key is encoded and transmitted to a second terminal. Communication contents are then encoded using the channel key and encoded communication contents are also transmitted to a second terminal. Upon receiving the encoded channel key and encoded communication contents, the following predetermined operations are performed. The encoded channel key is decoded and the encoded communication contents are decoded using the decoded channel key.

According to the present invention, it is possible to lower the probability of contents being intercepted by an unwanted third party in a telecommunication using mobile phones.

In addition, a contents protection function applied to mobile phones may also be applied to other digital communications devices, which is obvious to one skilled in the art.

In short, according to the present invention, it is possible to more effectively prevent call interception by providing a communication protection function to mobile phones.

What is claimed is:

1. A method of protecting communication contents, which are transmitted between a first terminal and a second terminal, the method comprising:
at a first terminal
encoding a predetermined channel key and transmitting the encoded channel key to the second terminal;
encoding communication contents using the channel key and transmitting the encoded communication contents to the second terminal;
at a second terminal
decoding the encoded channel key received from the first terminal; and
using the decoded channel key to decode the encoded communication contents received from the first terminal.

2. The method of claim 1, wherein the first terminal encodes the predetermined channel key using a predetermined public key.

3. The method of claim 2, wherein the predetermined public key is transmitted from the second terminal to the first terminal.

4. The method of claim 1, wherein the second terminal decodes the encoded channel key received from the first terminal using a predetermined private key.

5. The method of claim 4, wherein the second terminal decodes the encoded communication contents received from the first terminal using the decoded channel key.

6. A method of protecting communication contents transmitted between mobile phones, the method comprising:
causing mobile phones to share a predetermined channel key according to an asymmetric encryption method; and
encoding contents using the predetermined channel key according to a symmetric encryption method; and
transmitting the encoded contents between the mobile phones.

7. The method of claim 6, wherein causing the mobile phones to share a predetermined channel key comprises:
transmitting a predetermined public key from a mobile phone, which is a contents protection requesting party, to another mobile phone, which is an intended correspondent of the contents protection requesting party;
encoding, by the intended correspondent, a predetermined channel key using the predetermined public key and transmitting the encoded channel key to the contents protection requesting party; and
allowing the contents protection requesting party to decode the encoded channel key using a predetermined private key and to keep the decoded channel key.

8. The method of claim 6, wherein encoding the contents using the predetermined channel key according to a symmetric encryption method and transmitting the encoded contents between the mobile phones comprises:
a first of the mobile phones, which is a associated with a sending party, encoding contents using the predetermined channel key and transmitting the encoded contents to a second of the mobile phones, which is associated with a receiving party; and
the second of the mobile phones decoding the encoded contents using the predetermined channel key shared with the first of the mobile phones.

9. A mobile phone which protects contents, comprising:
a first memory for storing a private key and a public key used to perform asymmetric encryption;
a channel key encoder and decoder for encoding a predetermined channel key using a public key of a second memory and decoding an encoded channel key using the private key; and
a contents encoder and decoder for encoding contents to be protected and decoding encoded contents using the channel key.

10. A mobile phone which protects contents, comprising:
a first memory for storing a public key;
a second memory for storing a predetermined channel key;
a channel key encoder for encoding the channel key stored in the second memory using the public key stored in the first memory and transmitting the encoded channel key; and
a contents encoder for encoding predetermined contents using the channel key stored in the second memory and transmitting the encoded contents.

11. A mobile phone for protecting contents, comprising:
a first memory for storing a private key;
a channel key decoder for decoding encoded channel key input thereinto using the private key stored in the first memory; and
a contents decoder for decoding encoded contents input thereinto using the decoded channel key.

12. The mobile phone of claim 11 further comprising a second memory for storing a predetermined public key to be transmitted to a mobile phone, which has transmitted the encoded channel key to the channel key decoder.

13. A method of protecting contents, said method being performed in terminals which share a predetermined channel key following an asymmetric encryption method and perform, using the predetermined channel key, a contents protection mode, under which contents are transmitted between the terminals in a symmetric encryption method, the method comprising:
outputting a contents protection request message along with a notification sound when a contents protection request is received;
checking whether or not a user recognizes the contents protection request message while waiting for a predetermined amount of time; and
outputting a message saying that contents protection is being performed and performing the contents protection mode, if the user has recognized the contents protection request message.

14. A computer program product for exchanging encrypted information between two terminals comprising:
software instructions for enabling the computer to perform predetermined operations, and
a computer readable medium bearing the software instructions; the predetermined operations including:
encoding a predetermined channel key and transmitting the encoded channel key to a second terminal;
encoding communication contents using the channel key and transmitting the encoded communication contents to the second terminal;
wherein upon receiving an encoded channel key and encoded communication contents, the following instructions are performed:
decoding the encoded channel key and using the decoded channel key to decode the encoded communication contents.

15. The computer program product for exchanging encrypted information between two terminals of claim 14, wherein a predetermined public key is used to encode the predetermined channel key.

16. The computer program product for exchanging encrypted information between two terminals of claim 15, wherein the predetermined public key is shared between terminals.

17. The computer program product for exchanging encrypted information between two terminals of claim 14, wherein the encoded channel key is decoded using a predetermined private key.
